(19) United States
(12) Patent Application Publication
(10) Pub. No.: US 2007/0041290 A1
(43) Pub. Date: Feb. 22, 2007

(54) Optical head and optical information medium driving device

(76) Inventors: Hideki Nakata, KYOTO (JP); Hironori Tomita, Ikoma-shi (JP); Takeshi Ohta, Hirakata-shi (JP)

Correspondence Address: WENDEROTH, LIND & PONACK L.L.P., 2033 K. STREET, NW, SUITE 800, WASHINGTON, DC, 20006, US

(21) Appl. No.: 10/556,066

(22) PCT Filed: Oct. 22, 2004
(86) PCT No.: PCT/JP04/16062

§ 371 Date: Nov. 8, 2005

(30) Foreign Application Priority Data
Oct. 23, 2003 (JP) 2003-363062

(51) Int. Cl. G11B 7/00

(52) U.S. Cl. 369/44.37

(57) ABSTRACT

A semiconductor laser; a light flux separation element that separates a light flux emitted from the semiconductor laser for a first light flux and a second light flux to come out therefrom; an objective lens on which the first light flux coming out from the light flux separation element is incident to be collected on a optical information recording medium; a light-receiving element on which the second light flux coming out from the light flux separation element is incident; an arithmetic circuit that adjusts a quantity of light emitted from the light source in response to a quantity of light incident on the light-receiving element, are provided. A light exiting-surface of the light flux separation element from which the second light flux comes out is laminated to a light incident-surface of the light-receiving element on which the second light flux is incident via an adhesive layer. It is thus possible to adjust a quantity of light at a higher degree of accuracy and higher sensitivity while achieving a significant reduction of the optical head in size.

### BACKGROUND OF THE INVENTION

1. Field of the Invention

The present invention relates to an optical head adapted to an optical information medium driving device adopting a system by which information is optically recorded and played back by projecting a light spot on a disc-shaped recording medium.

2. Description of the Related Art

Recently, a disc recording and playback device has been expanding in application for a CD-ROM, a CD-R, an MD, a DVD-RAM, a Blu-ray disc, etc. from year to year, and the density, the performance, the quality, and added values are being enhanced; moreover, there has been a need for a significant reduction in size and cost. In particular, the demand for a portable disc recording and playback device with the recording capability tends to increase markedly, and there is a need to further reduce the device in size and thickness while improving the performance.

There have been many reports, such as JP-A-2000-048374, on the technique related to the optical head in an optical disc recording and playback device.

Hereinafter, an optical head in a disc recording and playback device for a magneto-optical disc will be described as an example of the optical head in the related art with reference to the drawings.

FIG. 13, FIG. 14A, FIG. 14B, FIG. 15A, FIG. 15B, and FIG. 16 show the schematic configuration or the principle of operation of the optical head in the related art. As is shown in FIG. 15A and FIG. 15B, a semiconductor laser 2 is fixed onto a silicon substrate 1, and a multi-splitting photo-detector 3 is formed on the silicon substrate 1 through the IC process. Also, a radiator plate 4 is held in a heat conduction state on the silicon substrate 1 via silver paste. Terminals 5 are wired to the multi-splitting photo-detector 3 through wire bonding or the like. These silicon substrate 1, radiator plate 4, and terminals 5 are held by a resin package 6. A hologram element (diffraction grating) 7 is fixed onto the resin package 6. The hologram element 7 is molded from resin. A composite element 8 is fixed onto the hologram element 7. The composite element 8 comprises a beam splitter 8a, a folding mirror 8b, and a polarization separation element 8c.

An integrated unit 9 comprises the silicon substrate 1, the semiconductor laser 2, the multi-splitting photo-detector 3, the radiator plate 4, the terminals 5, the resin package 6, the hologram element 7, and the composite element 8, which are formed as one unit. A reflection mirror 10 is disposed ahead of the integrated unit 9. The reflection mirror 10 is fixed onto an optical stand 19. Also, the integrated unit 9 is inserted inside the optical stand 19 after the terminals are soldered to a flexible circuit 35. The optical stand 19 and the resin package 6 are bonded and fixed to each other.

Light reflected on the reflection mirror 10 is collected on a magneto-optical recording medium 13 via an objective lens 11 to form a light spot 32. The magneto-optical recording medium 13 has the magneto-optic effect.

As is shown in FIG. 13, the objective lens 11 is driven by an objective lens moving mechanism 14 in the focus direction and the radial direction of the magneto-optical recording medium 13.

The objective lens moving mechanism 14 comprises components, such as the objective lens 11, an objective lens holder 12, a base 15, a suspension 16, a magnetic circuit 17, and coils 18a and 18b. The objective lens moving mechanism 14 is able to drive the objective lens 11 in the focus direction by energizing the coil 18a, and to drive the objective lens 11 in the radial direction by energizing the coil 18b. The base 15 is bonded and fixed to the optical stand 19 using adhesive 34.

The flexible circuit 35 is provided with a light-receiving element 36 for monitoring the laser, and an arithmetic circuit (not shown) that controls a quantity of light emitted from the semiconductor laser 2 in response to a quantity of light received on the light-receiving element 36. The light-receiving element 36 is soldered to the end portion of the flexible circuit 35, and is also electrically connected to the arithmetic circuit. In addition, as is shown in FIG. 15A, the light-receiving element 36 is disposed away from the composite element 8, so that a light flux separated in the beam splitter 8a in the composite element 8 goes incident thereon. The flexible circuit 35 is covered with a cover 33 and is fixed to the optical stand 19.

As is shown in FIG. 16, light-receiving regions 24 for a focus error signal, light-receiving regions 25 and 26 for a tracking error signal, and light-receiving regions 27 for an information signal are formed on the multi-splitting photo-detector 3. A light spot 20 for detecting a focus error signal is formed on the light-receiving regions 24 for a focus error signal, a light spot 21 for detecting a tracking error signal is formed on the light-receiving regions 25 and 26 for a tracking error signal, and a light spot 22 of a main beam (P-polarized light) and a light spot 23 of a main beam (S-polarized light) are formed on the light-receiving regions 27 for an information signal. The dimension of the optical stand 19 is defined in such a manner that the light-receiving regions 24 for a focus error signal are located at substantially the midpoint between the focal points 30 and 31 of the two light spots 20 and 20 in the Z-axis direction (optical axis direction) of the multi-splitting photo-detector 3. Subtracters 28 and an adder 29 are connected to the respective light-receiving regions 24, 25, 26 and 27.

Operations of the optical head in the related art configured as described above will now be described with reference to FIG. 14A, FIG. 14B, FIG. 15A and FIG. 15B.

Light emitted from the semiconductor laser 2 is separated into plural different light fluxes by means of the hologram element 7. The plural light fluxes go incident on the beam splitter 8a in the composite element 8. Part of the light fluxes passes through the beam splitter 8a and is reflected on the reflection mirror 10, after which it is collected on the magneto-optical recording medium 13 by passing through the objective lens 11 to form the light spot 32 having a diameter on the order of 1 μm. On the other hand, the rest of the light fluxes are reflected on the beam splitter 8a. These light fluxes go incident on the light-receiving element 36 for monitoring the laser, and a driving current of the semiconductor laser 2 is controlled in response to a quantity of received light.

Reflected light from the magneto-optical recording medium 13 travels through an inverse path to go incident on the beam splitter 8a in the composite element 8, and is thereby separated into plural light fluxes. Part of the incident light is reflected on the beam splitter 8a and goes incident on the polarization separation element 8c by way of the folding mirror 8b. The incident light is then separated into light fluxes of two polarization components that are orthogonal to each other by means of the polarization separation element 8c, and these light fluxes go incident on the light-receiving regions 27 for an information signal.

On the other hand, of the reflected light from the magneto-optical recording medium 13, a light flux that has passed through the beam splitter 8a is separated into plural light fluxes by means of the hologram element 7, and the separated light fluxes are collected on the light-receiving regions 24 for a focus error signal and on the light-receiving regions 25 and 26 for a tracking error signal.

By computing a difference between the main beam 22 comprising P-polarized light and the main beam 23 comprising the S-polarized light, it is possible to detect a magneto-optical disc information signal using the differential detection method. By further finding a sum of these beams, it is possible to detect a pre-pit signal.

The focus servo is performed through a so-called SSD method and the tracking servo is performed through a so-called push-pull method.

In order to obtain a desired detection signal on the basis of reflected light from the magneto-optical recording medium 13 in the optical head configured as described above, it is necessary to adjust a relative positional relation among the semiconductor laser 2, the objective lens 11, and the multi-splitting photo-detector 3 at the time of assembly. For adjustments of the positional relation, the initial position of a focus error signal in the Z-axis direction (optical axis direction) of the multi-splitting photo-detector 3 is set in such a manner that the light-receiving regions 24 for a focus error signal are located at substantially the midpoint between the focal points 30 and 31 of two light spots for detecting a focus error signal. The dimensions of the optical stand 19 and the resin package 6 in the integrated unit 9 are defined to enable such position settings.

Also, a tracking error signal is adjusted in the manner as follows. That is, a tracking error signal is adjusted so that outputs from the both light-receiving regions 25 and 26 for a tracking error signal are almost equal by holding the base 15 using an external jig (not shown), and by moving the objective lens moving mechanism 14 in the Y direction and in the X direction. This adjustment consequently brings the center of the objective lens 11 into agreement with the center of the light-emitting axis of the semiconductor layer 2.

Further, as are shown in FIGS. 14A and 14B, a relative tilt between the magneto-optical recording medium 13 and the objective lens 11 is adjusted in the manner as follows. That is, a relative tilt between the magneto-optical recording medium 13 and the objective lens 11 is adjusted by holding the base 15 using an external jig (not shown), and by performing the skew adjustment OR in the radial direction (about the Y-axis) and the skew adjustment OT in the tangential direction (about the X-axis). After the adjustments, the base 15 is bonded and fixed to the optical stand 19 using adhesive 34. The adjustment of a focus error signal, the adjustment of a tracking error signal, and the skew adjustments are completed in the manner described above, at which point the optical head is completed.

As has been described, in the optical head configured as in the related art, because the light-receiving element 36 and the arithmetic circuit are electrically connected, the light-receiving element 36 is provided to the flexible circuit 35. Hence, the light-receiving element 36 is disposed away from the composite element 8, and there is a possibility that the light-receiving element 36 is misaligned with respect to the composite element 8. This poses a problem that accuracy of detection using the light-receiving element 36 cannot be ensured.

### BRIEF SUMMARY OF THE INVENTION

The invention solves the problems in the related art, and has therefore an object to adjust a quantity of light at a higher degree of accuracy and higher sensitivity while achieving a significant reduction of the optical head in size.

In order to achieve the above and other objects, the invention provides an optical head including: a light source; a light flux separation element that separates a light flux emitted from the light source for at least a first light flux and a second light flux to come out therefrom; an objective lens on which the first light flux is incident to be collected on an optical information recording medium; a light-receiving element on which the second light flux is incident; an arithmetic circuit that adjusts a quantity of light emitted from the light source in response to a quantity of light incident on the light-receiving element; and a photo-detector on which reflected light from the optical information medium is incident. A light exiting-surface of the light flux separation element from which the second light flux comes out is laminated to a light incident-surface of the light-receiving element on which the second light flux is incident.

According to this configuration, because the light-receiving element is directly laminated to the light flux separation element, misalignment of the light-receiving element with respect to the optical axis or the light flux separation element can be lessened. In addition, as a distance between the light flux separation element and the light-receiving element becomes shorter, relative misalignment with respect to each other is lessened, which can in turn lessen a quantity of light arriving at a position outside of the light-receiving surface of the light-receiving element. Hence, not only is it possible to increase a quantity of light incident on the light-receiving element, but it is also possible to lessen influences of the misalignment, which can in turn suppress variance in detection sensitivity. As a result, a quantity of light can be detected at high detection sensitivity, and a quantity of light of the light source can be therefore adjusted at a higher degree of accuracy.

It is preferable that the light exiting-surface of the light flux separation element from which the second light flux comes out is laminated to the light incident-surface of the light-receiving element on which the second light flux is incident via an adhesive layer.

When the light exiting-surface of the light flux separation element and the light incident-surface of the light-receiving element are laminated to each other, a distance between the two components becomes shorter. A quantity of light incident on the monitor surface of the light-receiving element is thereby increased, and so is a quantity of light reflected on the monitor surface of the light-receiving element and on the surface of the package. Hence, there is a possibility that the reflected light turns to stray light that gives adverse effects to the accuracy of detection using the photo-detector. However, by interposing the adhesive layer between the light exiting-surface and the light incident-surface, it is possible to adjust a quantity of light incident on the light-receiving element, and a quantity and aberration of light that is reflected on the light-receiving element and go incident on the photo-detector as stray light. It is thus possible to reduce detection errors caused by stray light while maintaining a quantity of light incident on the light-receiving element.

It is preferable that the adhesive layer has light transmittance of 95% or below, and it is more preferable that the adhesive layer has light transmittance in a range from 40% to 95% both inclusive.

When the light transmittance of the adhesive layer is 95% or below, even when it is configured in such a manner that the light-receiving element is laminated to the light flux separation element, detection offset occurring in the photo-detector due to stray light from the light-receiving element can be reduced so as not to exceed the specified value. Also, when the light transmittance is 40% or above, it is possible to secure a quantity of light needed for the detection using the light-receiving element.

It is further preferable that the adhesive layer has light transmittance in a range from 60% to 80% both inclusive. When the light transmittance falls within this range, the recording and playback performance of the optical information recording medium can be stabilized. It is thus possible to make the optical head suitable for use in the recording and playback device for the optical information recording medium.

It is preferable that transmission wave aberration of the adhesive layer is set to 20 mλ or larger, and it is more preferable that transmission wave aberration is set in a range from 20 mλ to 300 mλ both inclusive.

When the transmission wave aberration of the adhesive layer is set to 20 mλ or larger, it is possible to blur or diffuse a light flux incident on the photo-detector, and to lessen bias of incidence of light on the photo-detector by providing adequate aberration to the both light fluxes: a light flux incident on the light-receiving element and a light flux reflected on the light-receiving element to go incident on the photo-detector. It is thus possible to keep detection offset in the photo-detector not to exceed the specified value in a reliable manner. Also, when the transmission wave aberration is set to 300 mλ or smaller, it is possible to secure a quantity of light needed for detection using the light-receiving element.

It is further preferable that the transmission wave aberration of the adhesive layer is set in a range from 60 mλ to 200 mλ both inclusive. When the transmission wave aberration falls within this range, the recording and playback performance of the optical information recording medium can be stabilized. It is thus possible to make the optical head suitable for use in the recording and playback device for the optical information recording medium.

It is preferable that the adhesive layer is made of UV-curing adhesive. When it is configured in such a manner that the light-receiving element is laminated to the light flux separation element through optical cementing using the UV bonding method or the like, it is easy to control aberration and light transmittance to fall within their respective specific ranges, which in turn enables bonding to be achieved at a high degree of accuracy.

In a case where an objective lens moving mechanism that moves the objective lens in a focus direction and in a tracking direction is provided, it is preferable that the objective lens moving mechanism includes a holder that holds the objective lens to be movable in the focus direction and in the tracking direction, and a base that supports the holder. And it is preferable that the light flux separation element is disposed so as to be set inside the base.

When configured in this manner, because part of the light flux separation element is set inside the base of the objective lens moving mechanism with an adjustment margin, a length of an optical path in the optical head can be shorter. It is thus possible to achieve a significant reduction of the optical head in size and thickness.

Further, the light-receiving element may be disposed to be set inside the base together with the light flux separation element.

When configured in this manner, because part of the light-receiving element is set inside the base of the objective lens moving mechanism with an adjustment margin, a projection area of the optical head can be smaller. This, therefore, contributes to a reduction of the disc recording and playback device in size.

Also, the invention can provide an optical information medium driving device, characterized by including: the optical head described above; a focus control circuit that controls the optical head on the basis of a focus error signal obtained from the optical head; and a tracking control circuit that controls the optical head on the basis of a tracking error signal obtained from the optical head.

### BRIEF DESCRIPTION OF THE DRAWINGS

FIG. 1 is a perspective view showing disassembled components forming an optical head according to one embodiment of the invention;

FIG. 2A and FIG. 2B are views each schematically showing an optical path in the optical head according to one embodiment of the invention;

FIG. 3A and FIG. 3B are views used to describe methods of the position adjustment and the skew adjustments in the optical head according to one embodiment of the invention;

FIG. 4 is a view schematically showing a multi-splitting photo-detector provided to the optical head according to one embodiment of the invention;

FIG. 5A and FIG. 5B are views each schematically showing the positional relation among a base, a composite element, and a light-receiving element in the optical head according to one embodiment of the invention;

FIG. 6A is a characteristic view showing a waveform of a focus error signal in the absence of offset, and FIG. 6B is a characteristic view showing a waveform of a focus error signal in the presence of offset;

FIG. 7A is a characteristic view showing a waveform of a tracking error signal in the absence of offset, and FIG. 7B is a characteristic view showing a waveform of a tracking error signal in the presence of offset;

FIG. 8 is a characteristic view showing a relation between light transmittance of an adhesive layer and offset of a servo signal;

FIG. 9 is a characteristic view showing a relation between light transmittance of the adhesive layer and a quantity of light needed for the light-receiving element;

FIG. 10 is a characteristic view showing a relation between transmission wave aberration of the adhesive layer and offset of a servo signal;

FIG. 11 is a characteristic view showing a relation between transmission wave aberration of the adhesive layer and a quantity of light needed for the light-receiving element;

FIG. 12 is a view schematically showing a major portion in an optical disc driving device to which the optical head according to one embodiment of the invention is adapted;

FIG. 13 is a perspective view showing disassembled components forming an optical head in the related art;

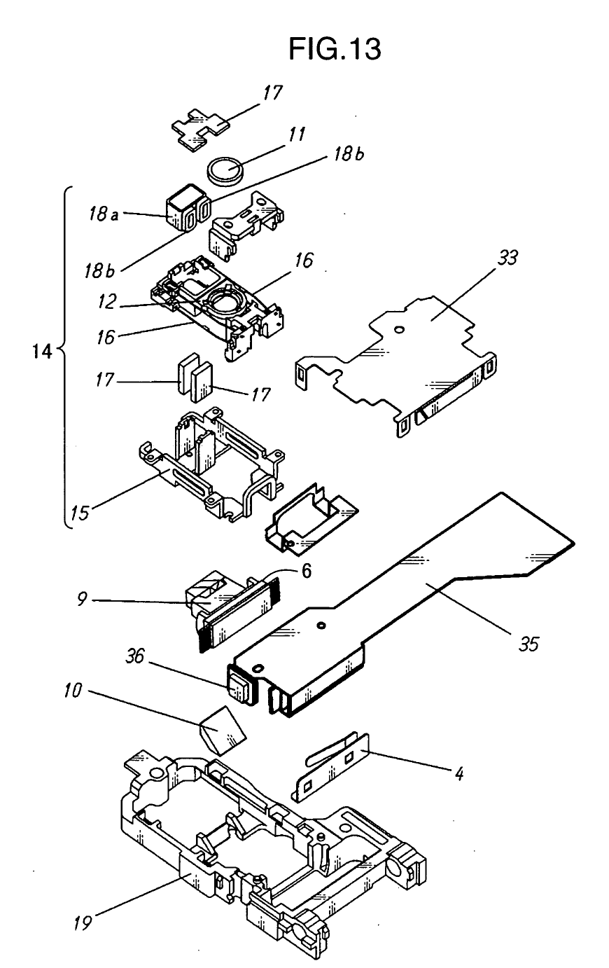

FIG. 14A and FIG. 14B are views used to describe methods of the position adjustment and the skew adjustments in the optical head in the related art;

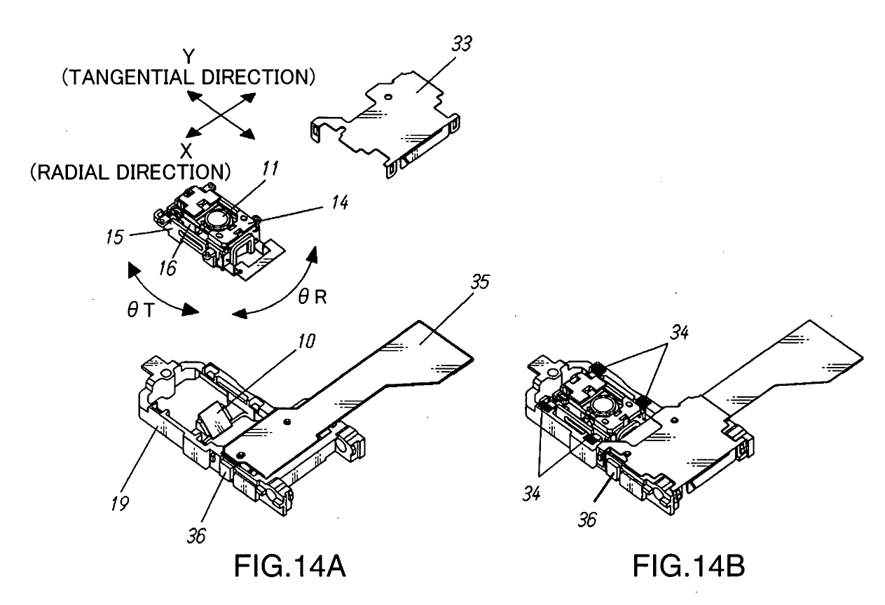

FIG. 15A and FIG. 15B are views schematically showing an optical path in the optical head in the related art; and

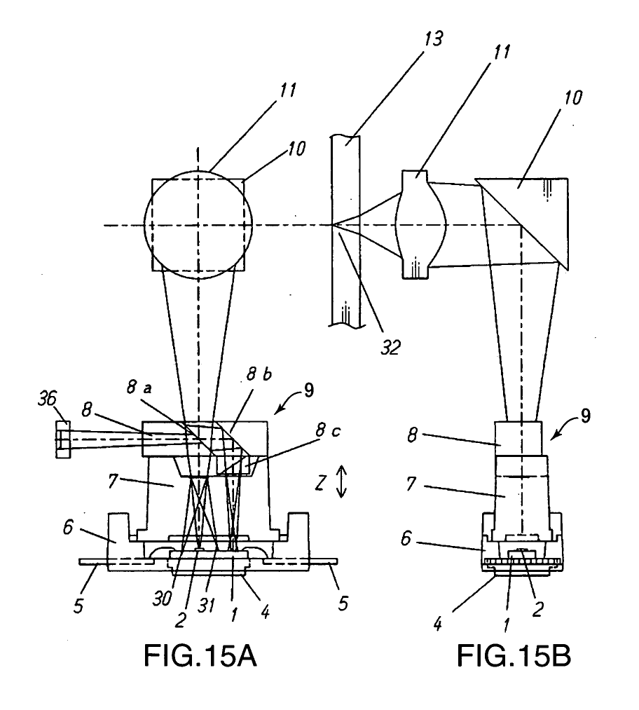

FIG. 16 is a view schematically showing a multi-splitting photo-detector provided to the optical head in the related art.

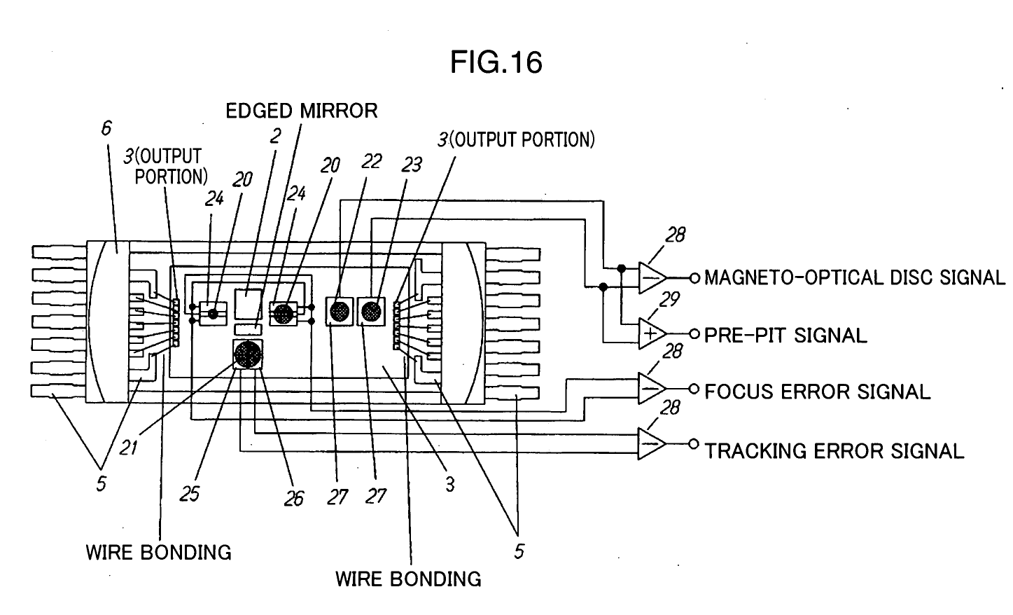

### DETAILED DESCRIPTION OF THE INVENTION

Hereinafter, one embodiment of the invention will be described with reference to the drawings.

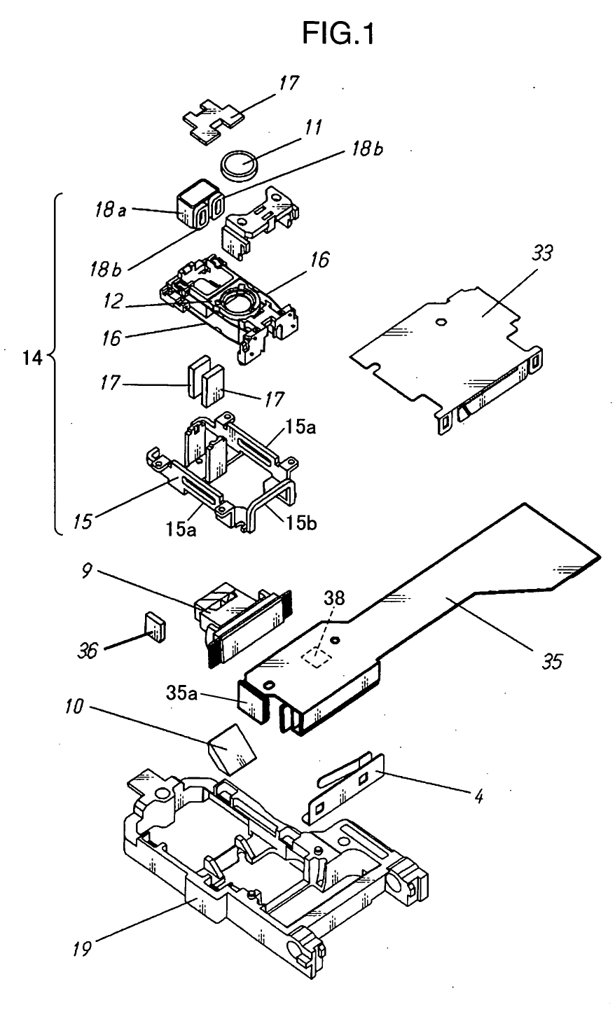

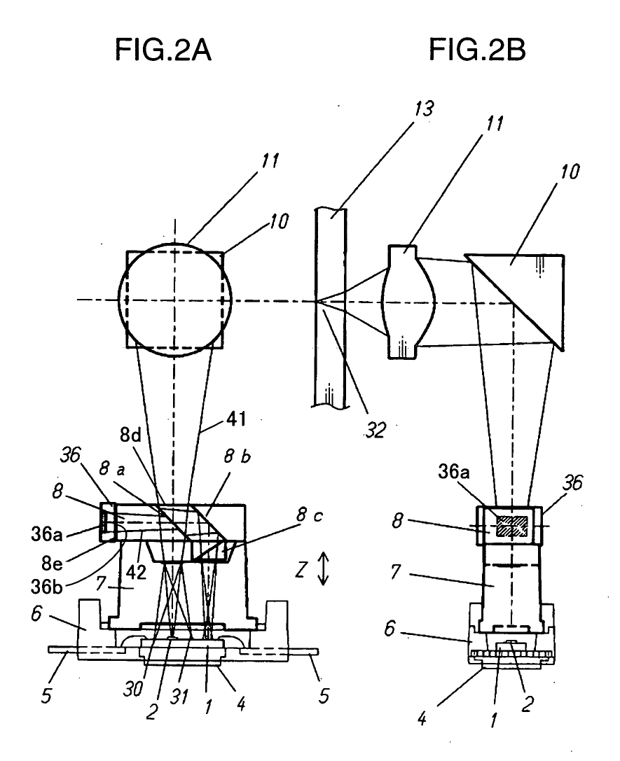

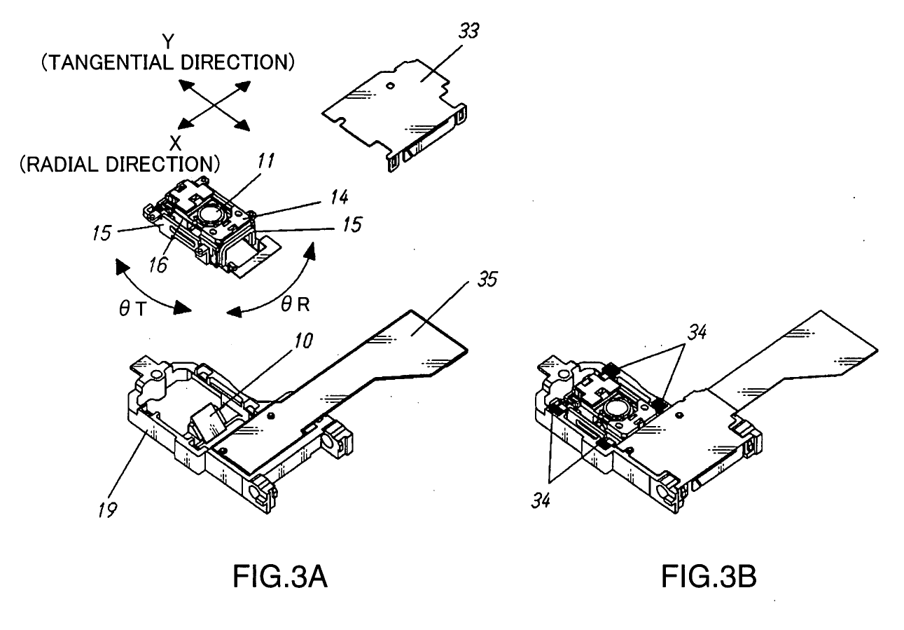

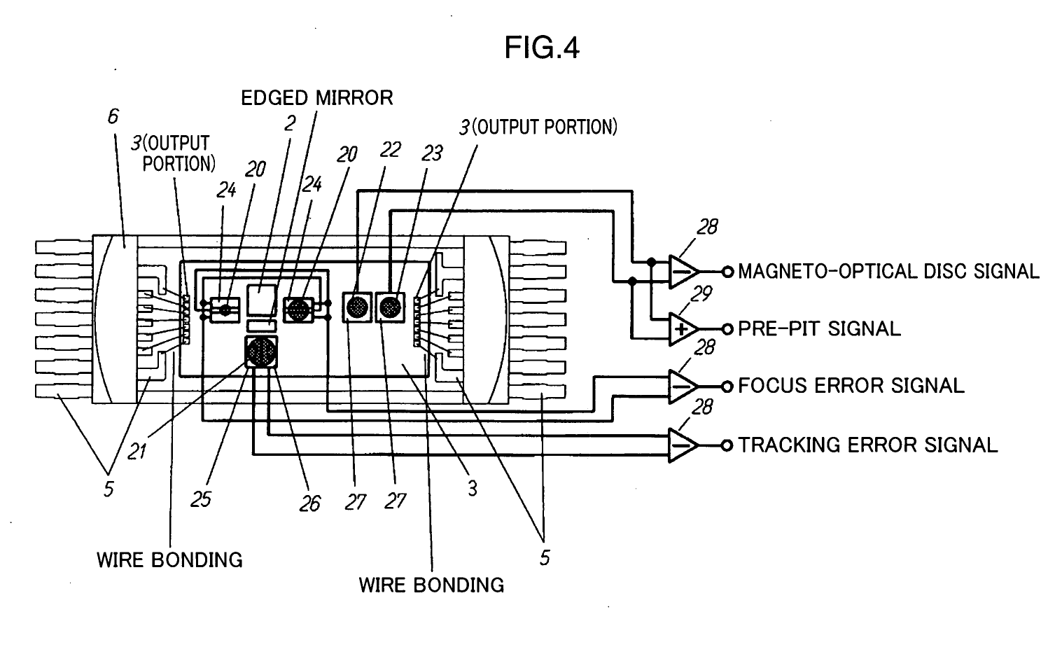

FIG. 1 is an exploded perspective view of an optical head according to one embodiment of the invention, and FIG. 2A and FIG. 2B are a schematic view showing an optical path in the optical head according to one embodiment of the invention. FIG. 3A and FIG. 3B show adjustment methods in the optical head according to one embodiment of the invention, and FIG. 4 is a schematic view of a photo-detector in the optical head according to one embodiment of the invention.

As are shown in FIG. 2A and FIG. 2B, a semiconductor laser 2 is fixed onto a silicon substrate 1, and a multi-splitting photo-detector 3 is formed on the silicon substrate 1 through the IC process. Also, a radiator plate 4 is held in a heat conduction state on the silicon substrate 1 via silver paste. Terminals 5 are wired to the multi-splitting photo-detector 3 through wire bonding or the like. These silicon substrate 1, radiator plate 4, and terminals 5 are held by a resin package 6. A hologram element (diffraction grating) 7 is fixed onto the resin package 6. The hologram element 7 is molded from resin. A composite element 8 is fixed onto the hologram element 7. The composite element 8 comprises a beam splitter 8a, a folding mirror 8b, and a polarization separation element 8c.

An integrated unit 9 comprises the silicon substrate 1, the semiconductor laser 2, the multi-splitting photo-detector 3, the radiator plate 4, the terminals 5, the resin package 6, the hologram element 7, and the composite element 8, which are formed as one unit. A reflection mirror 10 is disposed ahead of the integrated unit 9. The reflection mirror 10 is fixed onto an optical stand 19. Also, the integrated unit 9 is inserted inside the optical stand 19 after the terminals 5 are soldered to a flexible circuit 35. The optical stand 19 and the resin package 6 are bonded and fixed to each other.

Light reflected on the reflection mirror 10 is collected on a magneto-optical recording medium 13 via an objective lens 11 to form a light spot 32. The magneto-optical recording medium 13 has the magneto-optic effect.

As is shown in FIG. 1, the objective lens 11 is driven by an objective lens moving mechanism 14 in the focus direction and in the radial direction of the magneto-optical recording medium 13.

The objective lens moving mechanism 14 comprises components, such as the objective lens 11, an objective lens holder 12, a base 15, a suspension 16, a magnetic circuit 17, and coils 18a and 18b. The objective lens moving mechanism 14 is able to drive the objective lens 11 in the focus direction by energizing the coil 18a, and to drive the objective lens 11 in the radial direction by energizing the coil 18b. The base 15 is bonded and fixed to the optical stand 19 using an adhesive 34.

The objective lens 11 is held movably on the objective lens holder 12. The objective lens holder 12 is supported on the base 15. The base 15 is shaped like a frame, and is provided with a pair of pinching members 15a and 15a, and an arch-shaped linking member 15b that links the both pinching members 15a and 15a. The lens holder 12 is disposed so as to be surrounded by the both pinching members 15a and 15a and the linking member 15b.

The base 15 is bonded and fixed to the optical stand 19 using the adhesive 34. The flexible circuit 35 is covered with a cover 33, and the cover 33 is connected to the optical stand 19.

As is shown in FIG. 4, a pair of light-receiving regions 24 and 24 for a focus error signal, a pair of light-receiving regions 25 and 26 for a tracking error signal, and a pair of light-receiving regions 27 and 27 for an information signal are formed on the multi-splitting photo-detector 3. The light-receiving regions 24 and 24 for a focus error signal are disposed symmetric with respect to the semiconductor laser 2. Also, the light-receiving regions 25 and 26 for a tracking error signal are disposed symmetric with respect to the semiconductor laser 2. A light spot 20 for detecting a focus error signal is formed on each of the light-receiving regions 24 and 24 for a focus error signal, a light spot 21 for detecting a tracking error signal is formed on each of the light-receiving regions 25 and 26 for a tracking error signal, and a light spot 22 of a main beam (P-polarized light) and a light spot 23 of a main beam (S-polarized light) are formed respectively on the light-receiving regions 27 and 27 for an information signal. The dimension of the optical stand 19 is defined in such a manner that the light-receiving regions 24 for a focus error signal are located at substantially the midpoint between the focal points 30 and 31 of the two light spots 20 and 20 in the Z-axis direction (optical axis direction) of the multi-splitting photo-detector 3.

Both of the light-receiving regions 24 and 24 for a focus error signal are connected to a subtracter 28. Both of the light-receiving regions 25 and 26 for a tracking error signal are connected to a subtracter 28. Both of the light-receiving regions 27 and 27 for an information signal are connected to a subtracter 28 and an adder 29.

As is shown in FIG. 2A, the beam splitter 8a in the composite element 8 has an inclined plane tilted by approximately 45 degrees with respect to the optical axis between the semiconductor laser 2 and the reflection mirror 10. A light flux that is emitted from the semiconductor laser 2 and goes incident on the composite element 8 is separated into plural light fluxes by means of the beam splitter 8a.

The composite element 8 includes plural light exiting-surfaces 8d and 8e from which respective light fluxes separated in the beam splitter 8a come out. For example, the composite element 8 is provided with the main light exiting-surface 8d from which a first light flux 41 heading to the objective lens 11 from the composite element 8 comes out, and the sub light exiting-surface 8e from which a second light flux 42 separated from the main beam comes out. The main light exiting-surface 8d is formed so as to intersect with the optical axis between the semiconductor laser 2 and the reflection mirror 10 at right angles. Meanwhile, the sub light exiting-surface 8e is formed to intersect with the main light exiting-surface 8d almost at right angles on a side of the beam splitter 8a.

A light-receiving element 36 for monitoring the laser is laminated to the sub light exiting-surface 8e. The light-receiving element 36 is provided with a resin package, and a photo-detector 36a having a monitor surface is provided inside the package. The light-receiving element 36 receives the second light flux 42 separated from a light flux from the semiconductor laser 2 on the photo-detector 36a, and generates a current in response to a quantity of received light. A reflection preventive coating to suppress reflection of incident light is applied on the surface of the package. Nevertheless, the light-receiving element 36 reflects a few % to several dozen % of incident light on the surface of the package.

The light-receiving element 36 is soldered to the back surface (inner surface) of a folding portion 35a formed by folding the end portion of the flexible circuit 35. The flexible circuit 36 is provided with an arithmetic circuit 38 (see FIG. 1) that computes a quantity of light emitted from the semiconductor laser 2 on the basis of a current value and controls a quantity of light of the semiconductor laser 2 to be at a specified value.

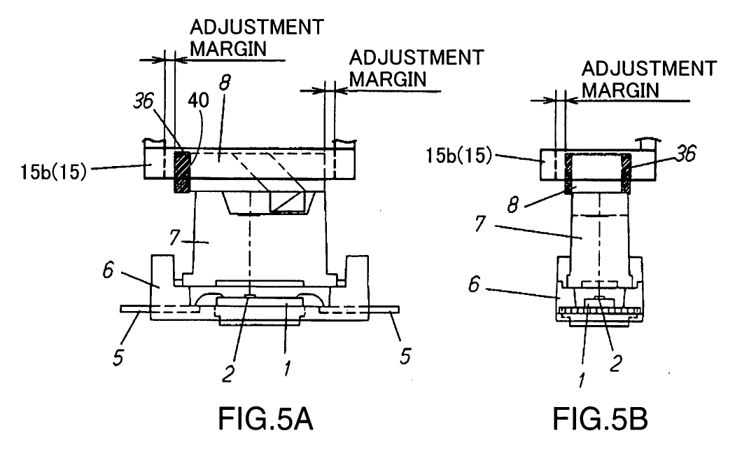

As are shown in FIG. 5A and FIG. 5B, the composite element 8 and the light-receiving element 36 are disposed in such a manner that part of each is set inside the base 15 with an adjustment margin. To be more concrete, the base 15 is provided with the arch-shaped linking member 15b as described above, and the composite element 8 and the light-receiving element 36 are set inside the base 15 through the interior of the linking portion 15b, while part of the composite element 8 and the light-receiving element 36 is accommodated in the base 15. Also, as are shown in FIGS. 5A and 5B, specific margins are provided between the linking portion 15b and each of the composite element 8 and the light-receiving element 36, so that the position adjustment and the skew adjustments by means of the objective lens moving mechanism 14 are enabled.

One surface of the package of the light-receiving element 36, that is, a light incident-surface 36b on which the second light flux 42 comes incident, is bonded and fixed to the composite element 8 via a adhesive layer 40. The adhesive layer 40 is made of, for example, UV-curing adhesive, and this bonding is so-called optical cementing. For instance, TB3087B available from Three Bond Co., Ltd. can be used as the adhesive.

The adhesive layer 40 transmits light fluxes in a quantity at a specific ratio with respect to a quantity of incident light while providing adequate transmission wave aberration. In other words, due to the presence of the adhesive layer 40, not only is it possible to adjust a quantity of light incident on the light-receiving element 36, but it is also possible to adjust a quantity and aberration of light incident on the multi-splitting photo-detector 3. A more detail description will be given below in this regard.

As a distance between the light-receiving element 36 and the composite element 8 becomes shorter, a quantity of light incident on the monitor surface of the light-receiving element 36 is increased correspondingly, and so is a quantity of stray light that is reflected on the light-receiving element 36 and returns to the multi-splitting photo-detector 3.

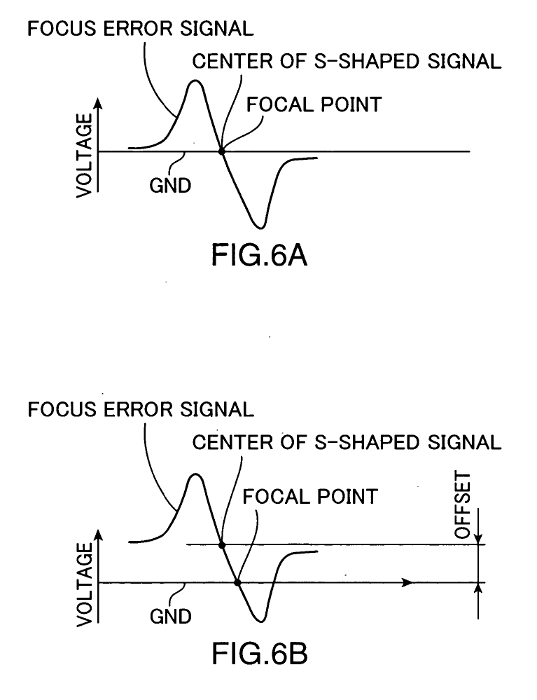

As has been described, both of the light-receiving regions 24 and 24 for a focus error signal on the multi-splitting photo-detector 3 are connected to the subtracter 28. When quantities of stray light received on the both light-receiving regions 24 and 24 are equal, as is shown in FIG. 6A, a focus error signal forms a waveform that is not offset with respect to GND. On the contrary, when there is a difference between the quantities of stray light, as is shown in FIG. 6B, a focus error signal forms a waveform that is offset with respect to GND.

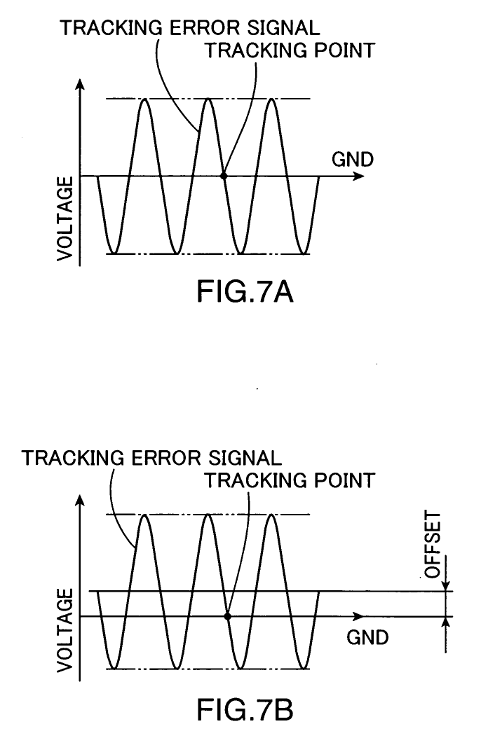

Meanwhile, as has been described, both of the light-receiving regions 25 and 26 for a tracking error signal are connected to the subtracter 28. When quantities of stray light received on the both light-receiving regions 25 and 26 are equal, as is shown in FIG. 7A, a tracking error signal forms a waveform that is not offset with respect to GND. On the contrary, when there is a difference between the quantities of stray light, as is shown in FIG. 7B, a tracking error signal forms a waveform that is offset with respect to GND.

For this reason, inconveniences caused by laminating the light-receiving element 36 to the composite element 8 are eliminated by defining light transmittance and transmission wave aberration of the adhesive layer 40.

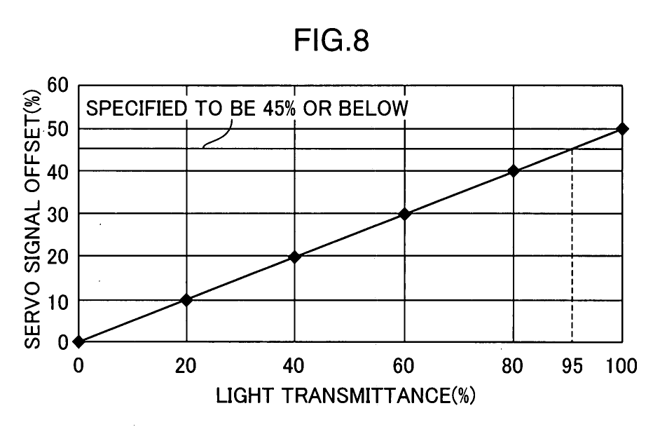

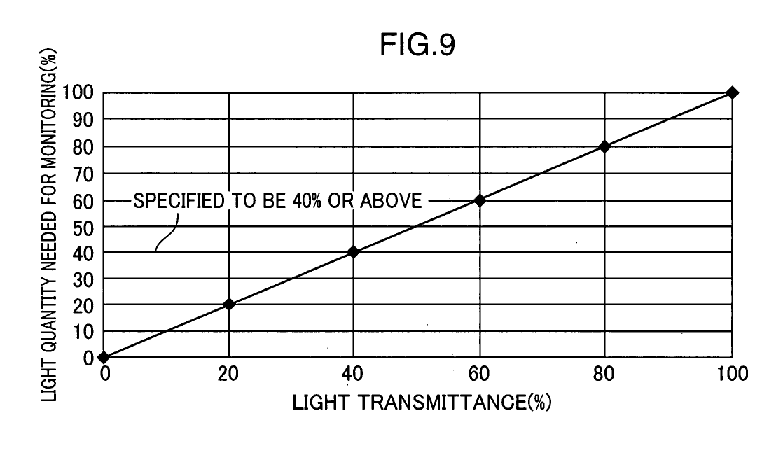

To be more concrete, it is preferable that the adhesive layer 40 has light transmittance in a range from 40% to 95% both inclusive, and it is more preferable that it has light transmittance in a range from 60% to 80% both inclusive. As is shown in FIG. 8, when the light transmittance of the adhesive layer 40 is 95% or below, even when it is configured in such a manner that the light-receiving element 36 is laminated to the composite element 8, offset of a servo signal, caused in the respective light-receiving regions 24, 24, 25, and 26 on the multi-splitting photo-detector 3 due to stray light from the light-receiving element 36, can be reduced so as not to exceed the specified value. Also, as is shown in FIG. 9, when the light transmittance is 40% or above, it is possible to secure a quantity of light needed for the detection using the light-receiving element 36. In addition, when the light transmittance is in a range from 60% to 80% both inclusive, the recording and playback performance of the magneto-optical recording medium 13 can be stabilized. It is thus possible to make the optical head suitable for use in the recording and playback device for the magneto-optical recording medium 13.

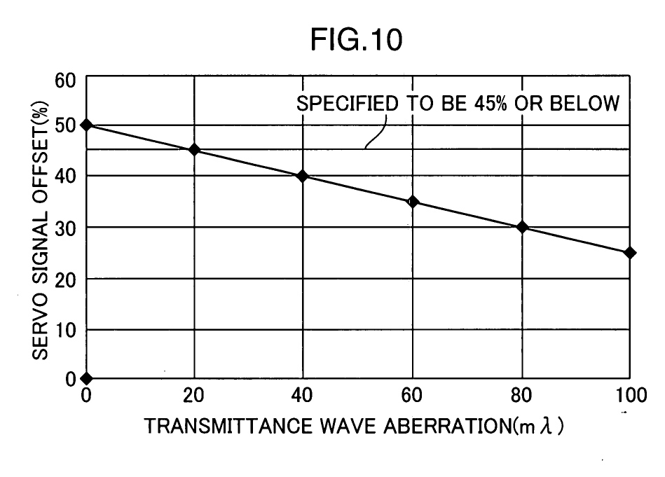

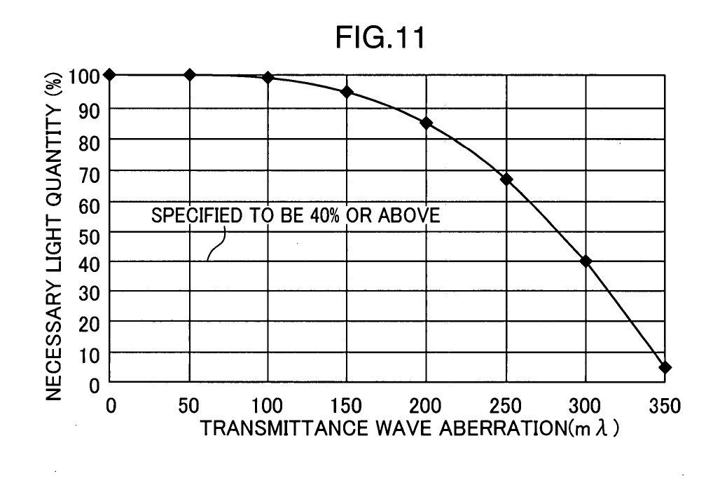

Further, it is preferable for the adhesive layer 40 that the transmission wave aberration is set in a range from 20 mλ to 300 mλ both inclusive, and it is more preferable that the transmission wave aberration is set in a range from 60 mλ to 200 mλ both inclusive. As is shown in FIG. 10, when the transmission wave aberration is set to 20 mλ or larger, it is possible to blur or diffuse a light flux incident on the multi-splitting photo-detector 3, and to lessen bias of incidence of light on the respective light-receiving regions 24, 24, 25, and 26 by providing adequate aberration to the both light fluxes: the second light flux 42 incident on the light-receiving element 36 and a light flux reflected on the light-receiving element 36 to go incident on the multi-splitting photo-detector 3. It is thus possible to keep the offset of a servo signal so as not to exceed the specified value in a reliable manner. Also, as is shown in FIG. 11, when the transmission wave aberration is set to 300 mλ or smaller, it is possible to secure a quantity of light needed for detection using the light-receiving element 36.

Operations of the optical head of this embodiment configured as described above will now be described with reference to FIGS. 2A, 2B and FIGS. 3A, 3B. Light emitted from the semiconductor laser 2 is separated into plural different light fluxes by means of the hologram element 7. The plural light fluxes go incident on the beam splitter 8a in the composite element 8. The first light flux 41 passes through the beam splitter 8a and is reflected on the reflection mirror 10, after which it is collected on the magneto-optical recording medium 13 by passing through the objective lens 11 fixed to the objective lens holder 12 to form the light spot 32 having a diameter on the order of 1 μm. On the other hand, the second light flux 42 is reflected on the beam splitter 8a. The light flux 42 goes incident on the light-receiving element 36 for monitoring the laser, and the arithmetic circuit 38 controls a driving current of the semiconductor laser 2 in response to a quantity of light received on the light-receiving element 36.

Reflected light from the magneto-optical recording medium 13 travels through an inverse path to go incident on the beam splitter 8a in the composite element 8, and is thereby separated into plural light fluxes. Part of the incident light is reflected on the beam splitter 8a and goes incident on the polarization separation element 8c by way of the folding mirror 8b. The semiconductor laser 2 is disposed to have a polarization direction parallel to the sheet surface of FIG. 2A. The incident light is then separated into light fluxes of two polarization components that are orthogonal to each other by means of the polarization separation element 8c, and these light fluxes go incident on the light-receiving regions 27 for an information signal.

On the other hand, of the reflected light from the magneto-optical recording medium 13, a light flux that has passed through the beam splitter 8a is separated into plural light fluxes by means of the hologram element 7, and the separated light fluxes are collected on the light-receiving regions 24 for a focus error signal and on the light-receiving regions 25 and 26 for a tracking error signal.

By computing a difference between the main beam 22 comprising P-polarized light and the main beam 23 comprising the S-polarized light, it is possible to detect a magneto-optical disc information signal using the differential detection method. By further finding a sum of these beams, it is possible to detect a pre-pit signal.

The focus servo is performed through a so-called SSD method and the tracking servo is performed through a so-called push-pull method.

In order to obtain a desired detection signal on the basis of reflected light from the magneto-optical recording medium 13 in the optical head configured as described above, it is necessary to adjust a relative positional relation among the semiconductor laser 2, the objective lens 11, and the multi-splitting photo-detector 3 at the time of assembly. For adjustments of the positional relation, the initial position of a focus error signal is set in such a manner that the light-receiving regions 24 for a focus error signal are located at substantially the midpoint between the focal points 30 and 31 of two light spots for detecting a focus error signal in the Z-axis direction (optical axis direction) of the multi-splitting photo-detector 3. The dimensions of the optical stand 19 and the resin package 6 in the integrated unit 9 are defined to enable such position settings.

Also, a tracking error signal is adjusted in the manner as follows. That is, a tracking error signal is adjusted so that outputs from the both light-receiving regions 25 and 26 for a tracking error signal are almost equal by holding the base 15 using an external jig (not shown), and by moving the objective lens moving mechanism 14 in the Y direction and in the X direction. This adjustment consequently brings the center of the objective lens 11 into agreement with the center of the light-emitting axis of the semiconductor layer 2 as is shown in FIG. 2A and FIG. 2B.

Further, as are shown in FIGS. 3A and 3B, a relative tilt between the magneto-optical recording medium 13 and the objective lens 11 is adjusted in the manner as follows. That is, a relative tilt between the magneto-optical recording medium 13 and the objective lens 11 is adjusted by holding the base 15 using an external jig (not shown), and by performing the skew adjustment OR in the radial direction (about the Y-axis) and the skew adjustment OT in the tangential direction (about the X-axis). After the adjustments, the base 15 is bonded and fixed to the optical stand 19 using the adhesive 34. The adjustment of a focus error signal, the adjustment of a tracking error signal, and the skew adjustments are completed in the manner described above, at which point the optical head is completed. In this instance, the adjustment margins in three points shown in FIG. 5A and FIG. 5B take values that take account of the X-Y plane adjustment, the skew adjustment θR in the radial direction (about the Y-axis), and the skew adjustment θT in the tangential direction (about the X-axis) by means of the objective lens moving mechanism 14.

As has been described, according to this embodiment, because the light-receiving element 36 is laminated to the light flux transmitting portion of the composite element 8 that transmits a sub-beam, it is possible to lessen misalignment of the light-receiving element 36 with respect to the optical axis or the composite element 8. Also, as a distance between the composite element 8 and the light-receiving element 36 becomes shorter, relative misalignment between these components is lessened, which can in turn lessen a quantity of light arriving at a position outside of the photo-detector 36a of the light-receiving element 36. Hence, not only is it possible to increase a quantity of light incident on the light-receiving element 36, but it is also possible to reduce influences of the misalignment. It is thus possible to detect a quantity of light of the semiconductor laser 2 in a stable manner by suppressing variance in detection sensitivity. As a consequence, a quantity of light can be detected at high detection sensitivity, which in turn enables a quantity of light of the semiconductor laser 2 to be adjusted at a high degree of accuracy. In addition, influences of accumulated tolerance of components can be reduced.

Moreover, in this embodiment, because the sub light exiting-surface 8e of the composite element 8 and the light incident-surface 36b of the light-receiving element 36 are laminated via the adhesive layer 40, a quantity of light incident on the light-receiving element 36 and a quantity and aberration of stray light reflected on the light-receiving element 36 to go incident on the multi-splitting photo-detector 3 can be adjusted using the adhesive layer 40. Hence, by bringing the light-receiving element 36 closer to the composite element 8, detection errors caused by stray light that goes incident on the respective light-receiving regions 24, 24, 25, and 26 can be reduced while maintaining a quantity of light incident on the light-receiving element 36. It is thus possible to obtain a highly accurate optical head.

In addition, because it is possible to detect a quantity of light of the semiconductor laser 2 at a position closer to the semiconductor laser 2, a light flux having a large power distribution is received. A quantity of detected light therefore becomes so large that a quantity of light of the light source can be adjusted at a high degree of accuracy and high sensitivity.

Moreover, because the light-receiving element 36 and the composite element 8 are bonded through optical cementing using the UV bonding method or the like, it is easy to control aberration and light transmittance to fall within their respective specific ranges, which enables bonding to be achieved at a high degree of accuracy.

Further, because part of the composite element 8 is set inside the objective lens moving mechanism 14 with an adjustment margin, the optical head can be reduced in size and thickness. In addition, a length of the optical path in the optical head can be shorter.

Also, because part of the light-receiving element 36 is set inside the objective lens moving mechanism 14 with an adjustment margin, a projection area in the X-Y plane of the optical head can be smaller. This enables a further reduction in size and thereby contributes to a reduction of the disc recording and playback device in size. Hence, a compact and slim and yet high-performance disc recording and playback device can be achieved.

In this embodiment, it is configured in such a manner that the composite element 8 and the light-receiving element 36 are set inside the base 15 of the objective lens moving mechanism 14. However, it may be configured in such a manner that the composite element 8 or the light-receiving element 36 is accommodated in any other component forming the objective lens moving mechanism 14 depending on the configuration of the objective lens moving mechanism 14.

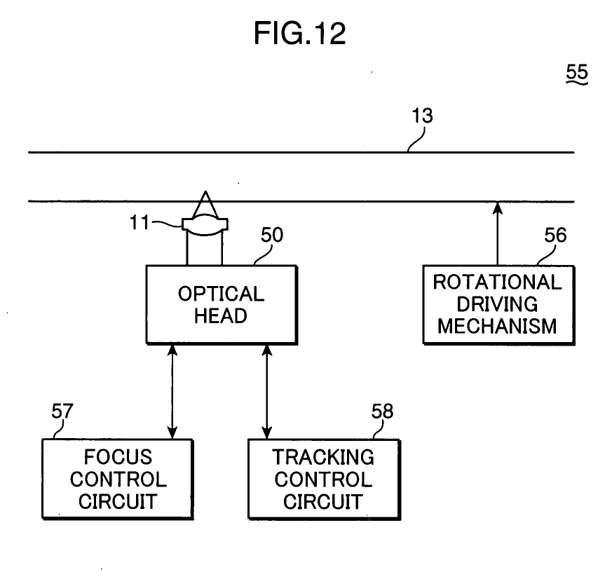

An optical disc driving device 55 to which the optical head 50 of this embodiment is adapted will now be described. As is shown in FIG. 12, the optical disc driving device 55 includes a rotational driving mechanism 56 to rotate the magneto-optical recording medium 13, the optical head 50, a focus control circuit 57, and a tracking control circuit 58. The focus control circuit 57 computes a focus error signal on the basis of light-reception signals from the light-receiving regions 24 for a focus error signal, and controls the position of the objective lens 11 on the basis of this focus error signal. The tracking control circuit 58 computes a tracking error signal on the basis of light-reception signals from the light-receiving regions 25 and 26 for a tracking error signal, and controls the position of the objective lens 11 on the basis of this tracking error signal. The position of the objective lens 11 is moved in a direction that intersects with the magneto-optical recording medium 13 at right angles and in the radius direction of the magneto-optical recording medium 13, so that information is recorded and played back by allowing the collected light spot 32 to follow on a specific information track on the magneto-optical recording medium 13.

According to this configuration, not only can a compact and highly accurate optical disc driving device be achieved, but also recording and playback properties at a high degree of accuracy can be achieved.

This application is based on Japanese patent application serial No. 2003-363062, filed in Japan Patent Office on Oct. 23, 2003, the contents of which are hereby incorporated by reference.

Although the present invention has been fully described by way of example with reference to the accompanied drawings, it is to be understood that various changes and modifications will be apparent to those skilled in the art. Therefore, unless otherwise such changes and modifications depart from the scope of the present invention hereinafter defined, they should be construed as being included therein.

### INDUSTRIAL APPLICABILITY

As has been described, the invention is useful as an optical head that adjusts a quantity of light emitted from the light source, and is further applicable to an information processing device, such as a computer, a disc recording and playback device, and a car navigation system, that outputs necessary information by applying desired processing to a signal detected using the optical head.

1-14. (canceled)

15. An optical head, comprising:
a light source;
a light flux separation element that separates a light flux emitted from the light source for at least a first light flux and a second light flux to come out therefrom;
an objective lens on which the first light flux is incident to be collected on an optical information recording medium;
a light-receiving element on which the second light flux is incident;
an arithmetic circuit that adjusts a quantity of light emitted from the light source in response to a quantity of light incident on the light-receiving element; and
a photo-detector on which reflected light from the optical information medium is incident,
wherein a light exiting-surface of the light flux separation element from which the second light flux comes out is laminated to a light incident-surface of the light-receiving element on which the second light flux is incident.

16. The optical head according to claim 15, wherein:
the light exiting-surface of the light flux separation element from which the second light flux comes out is laminated to the light incident-surface of the light-receiving element on which the second light flux is incident via a adhesive layer.

17. The optical head according to claim 16, wherein:
the adhesive layer has light transmittance of 95% or below.

18. The optical head according to claim 17, wherein:
the adhesive layer has the light transmittance of 40% or above.

19. The optical head according to claim 17, wherein:
the adhesive layer has the light transmittance of 80% or below.

20. The optical head according to claim 19, wherein:
the adhesive has the light transmittance of 60% or above.

21. The optical head according to claim 16, wherein:
transmission wave aberration of the adhesive layer is set to 20 mλ or larger.

22. The optical head according to claim 21, wherein:
transmission wave aberration of the adhesive layer is set to 300 mλ or smaller.

23. The optical head according to claim 21, wherein:
transmission wave aberration of the adhesive layer is set to 60 mλ or larger.

24. The optical head according to claim 23, wherein:
transmission wave aberration of the adhesive layer is set to 200 mλ or smaller.

25. The optical head according to claim 16, wherein:
the adhesive layer is made of UV-curing adhesive.

26. The optical head according to claim 15, further comprising:
an objective lens moving mechanism that moves the objective lens in a focus direction and in a tracking direction, wherein:
the objective lens moving mechanism includes a holder that holds the objective lens to be movable in the focus direction and in the tracking direction, and a base that supports the holder; and
the light flux separation element is disposed so as to be set inside the base.

27. The optical head according to claim 26, wherein:
the light-receiving element is disposed so as to be set inside the base together with the light flux separation element.

28. An optical information medium driving device, comprising:
an optical head;
a focus control circuit that controls the optical head on the basis of a focus error signal obtained from the optical head; and
a tracking control circuit that controls the optical head on the basis of a tracking error signal obtained from the optical head,
the optical head including:
a light source;
a light flux separation element that separates a light flux emitted from the light source for at least a first light flux and a second light flux to come out therefrom;
an objective lens on which the first light flux is incident to be collected on an optical information recording medium;
a light-receiving element on which the second light flux is incident;
an arithmetic circuit that adjusts a quantity of light emitted from the light source in response to a quantity of light incident on the light-receiving element; and
a photo-detector on which reflected light from the optical information medium is incident,
wherein a light exiting-surface of the light flux separation element from which the second light flux comes out is laminated to a light incident-surface of the light-receiving element on which the second light flux is incident.
